(19) United States
(12) Patent Application Publication
(10) Pub. No.: US 2009/0127986 A1
(43) Pub. Date: May 21, 2009

(54) Furniture

(76) Inventor: Hermanus Lukas Carelsen, New South Wales (AU)

Correspondence Address: JOEL D. SKINNER, JR.;SKINNER AND ASSOCIATES, 212 COMMERCIAL ST., HUDSON, WI, 54016, US

(21) Appl. No.: 11/921,060

(22) PCT Filed: May 26, 2006
(86) PCT No.: PCT/AU2006/000705

§ 371 Date: Sep. 22, 2008

(30) Foreign Application Priority Data
May 26, 2005 (AU) 2005902717

(51) Int. Cl. A47B 21/013; E05B 65/44

(52) U.S. Cl. 312/204; 70/78

(57) ABSTRACT

The present invention relates to an article of furniture, such as a desk or cabinet which has a horizontal display (1) or storage surface that is capable of displaying objects and that also contains a storage compartment (2) having its own display (7) or storage surface on which various objects can rest. The storage compartment may be lowered and concealed within the furniture article, and then whenever desired, it may be raised to display and allow access to any objects that it contains. Preferably the compartment is moved by electrically powered mechanism such as a cable and drum motor. There may be guidance means, such as a track (3), to assist the movement of the cabinet, as well as adjustment means to allow the two display surfaces to be positioned flush with each other when the display cabinet is in its raised position.

### TECHNICAL FIELD

The present invention relates to an article of furniture, such as a desk, display unit, or cabinet, which has a horizontal display or storage surface that is capable of displaying objects, and that also contains a storage compartment having its own display or storage surface on which various objects can rest. The storage compartment may be lowered and concealed within the furniture article, and then whenever desired, it may be raised to display and allow access to any objects that it contains. By this means, the total display area of the furniture is increased. When the storage compartment is in its lowered position within the article of furniture, it is preferably concealed from view, which functions as a security feature. Preferably, it then may also be locked into place as an additional security feature. A variety of means can be used to lower and raise the storage compartment, but preferably an electric driven drum and cable arrangement is utilised for this purpose. When the compartment is in its raised position, its display area is more or less flush with the furniture's display area, allowing the two areas to be utilised as a single area.

The invention also concerns a kit, which comprises a storage compartment with its associated fittings that can be affixed to an existing article of furniture, to create a furniture unit containing the storage compartment as described above.

### BACKGROUND ART

There is a need for an article of furniture, such as a desk or a cabinet like a television display cabinet, for example, which includes a storage compartment that can be concealed from view. This provides additional security so that, for example, computer equipment on the desk can be stored out of sight and within the piece of furniture. The advantage is that if someone were planning to steal or use the equipment in an unauthorised manner, firstly they would have trouble locating it, and secondly the equipment's location with the storage cabinet can prevent either action occurring. Many thefts, especially in offices, are caused by impulsive behaviour, and if expensive and portable objects are stored out of sight in difficult to get at positions, there is likely to be less stealing. This approach can also be usefully employed in retail locations, where a cash register or the like can be lowered into storage when the retail assistant is away from the counter, or when the store is closed.

A second consideration for utilising a concealed storage compartment in an item of furniture is aesthetic. The furniture will look neater if utilitarian objects are hidden from view. Computer equipment, for example, often looks untidy, with many cables and separate items, and being able to hide this from view is often desirable. It is also useful to hide papers, notes, bills and everyday ephemera from view, which looks neater and has the further advantage that once away from sight and in storage, the material cannot be disarranged or lost.

Furniture with a storage compartment may meet both of the criteria of having improved security and good aesthetics, for example, when displaying a collection, such as of books, coins, stamps, or trading cards, for instance. In this case the compartment may be designed to hold the collection in a meaningful and useful order, so that the collection can be locked away for much of the time, and then displayed to advantage whenever this is desired.

Yet a further advantage of having a storage compartment that can be raised is to increase the display area, and to utilise otherwise wasted space. The top or covering of the storage compartment functions as a display or work area when the compartment has been lowered down into its concealed position. But when it is raised, the base of the storage compartment functions as an additional display and work area. As well, the storage compartment itself may have extra display shelves and compartments built in it.

Another advantage for using such a storage compartment is to provide protection for fragile or easily damaged objects, which can be stored out of sight when not in use, preventing their accidentally being damaged by children or by misadventure. For example, an expensive and relatively fragile plasma television screen may be kept in the storage compartment of a television cabinet to avoid it being damaged when it is not being used.

While a variety of mechanisms for raising and lowering the storage compartment may be used, it would be advantageous to use an electrically powered means, so that the user does not need to exert themselves to raise the compartment and its possibly heavy contents. A simple, robust, compact and relatively inexpensive mechanism would also be advantageous, and in particular, a cable and drum mechanism is a preferred mechanism, by meeting these objectives, although other mechanisms are also possible. It is also preferred to provide some simple and effective means for levelling the surfaces, so that they can be adjusted to become flush again, should the raising and lowering mechanism become misadjusted through use, for example.

It would therefore be useful to provide an article of furniture that shares at least one of these advantages, or provides a useful alternative approach.

### DISCLOSURE OF THE INVENTION

These and other advantages are met with the present invention, which in one broad form concerns an article of furniture having a substantially horizontal first display surface, a concealable storage compartment having at least one substantially horizontal second display surface for storing objects, wherein the storage compartment may be repetitively raised substantially vertically from a fixed and concealed position to a fixed and displayed position, and lowered back again, and when in the fixed and displayed position, the first and second display surfaces are substantially flush, and when in the fixed and concealed position the storage compartment is substantially concealed from view within the article of furniture.

As one preferred embodiment, the concealable storage compartment has a bottom surface comprising the second display surface, at least one side surface, and a top surface, and when the storage compartment is in the fixed and concealed position the top surface is substantially flush with the first display surface. As another embodiment, the concealable storage compartment has a bottom surface comprising the second display surface, and when in the fixed and concealed position the storage compartment is substantially concealed within the article of furniture by being covered by a substantially horizontal third display surface that then may be displaced to permit the storage compartment to be raised, and when in the fixed and displayed position, the third display surface is substantially flush with the first display surface. In this situation, the third display surface may be pivoted along an axis that is one edge of the third surface. As another embodiment, the concealable storage compartment may have a bottom surface comprising the second display surface, and when in the fixed and concealed position the storage compartment is substantially concealed within the article of furniture by being covered by the first display surface that then may be displaced substantially horizontally to allow the storage compartment to be raised, and when in the fixed and displayed position, the second display surface is substantially flush with the first display surface.

Preferably, the article of furniture may be a desk, a display unit, or a cabinet. It may also include a locking means to secure the storage compartment when in its concealed position. This locking means may itself be concealed, and may be a keyed lock. It is preferred that the storage compartment is substantially entirely enclosed when in its concealed position so as to secure the objects in the storage compartment. The storage compartment may have an outer container into which it is lowered that substantially entirely encloses it when in its concealed position, so as to secure the objects in the storage compartment. The storage compartment may be held in its fixed and displayed position by another locking means.

Preferably, the article of furniture may also include some guidance means to assist with guiding the up and down movement of the storage compartment. It may also include some adjustment means to allow the first and second display surface to be aligned more precisely flush with each other. Preferably it may be raised or lowered by some substantially electrically operated means. In this situation, the electrically operated means may include some control means in the form of a switch. Also, preferably, the means for the raising and lowering may be selected from among: a cable and drum mechanism, a rack and pinion mechanism, a chain and sprocket mechanism, or a linear actuator mechanism. Most preferably, the means for the raising and lowering is a cable and drum mechanism.

If so, the cable and drum mechanism may includes two or more cables connecting the storage compartment to the drum mechanism around which the cables are wound, whereby a cable is fixed to each end of the storage compartment, and at or near the centre balance point of the compartment. In another embodiment, the cable may pass over two or more pulleys, at least one of which can be repositioned to extend or reduce the total path of each cable's travel, and thereby allowing adjustment of the alignment of the storage compartment relative to the first display surface. The article of furniture may, if desired, also includes a cable guide for containing cables, that extends between the storage compartment and a position near to the base of the article of furniture, the cable guide be so arranged to minimise the change in the length of the path though the cable guide as the storage compartment moves up and down.

Another aspect of the invention concerns a kit for adapting an article of furniture to include a storage compartment.

### BRIEF DESCRIPTION OF DRAWINGS

The invention is now discussed with reference to drawings, where:

FIG. 1 shows a desk unit of the invention with its storage compartment in a lowered position;

FIG. 2 shows the desk unit of FIG. 1 with the storage compartment in its raised position;

FIG. 3 shows an alternative version of a desk unit of the invention with its storage compartment in its lowered position;

FIG. 4 shows the desk unit of FIG. 3 with its storage compartment still in its lowered position, but with a section of the desk's top open so as to allow the storage unit to be raised;

FIG. 5 shows the desk unit of FIGS. 3 and 4 with the storage compartment raised;

FIG. 6 shows another version of the invention, as a cabinet with its storage compartment in a lowered position;

FIG. 7 shows the cabinet of FIG. 6 with its storage compartment still in the lowered position, but with desk's top and sides moved horizontally allowing the storage unit to be raised;

FIG. 8 shows the cabinet of FIGS. 6 and 7 with the compartment in its raised position;

FIG. 9 shows another aspect of the invention, as a kit for adding a storage compartment to an existing desk unit, the desk having been remodelled to allow this;

FIG. 10 shows the desk and storage compartment combination of FIG. 9 with the storage compartment attached to the desk, in its raised position;

FIG. 11 shows another version of the invention, as a corner desk unit having a display unit of an irregular shape in its raised position;

FIG. 12 shows the kit of FIGS. 9 & 10 with the storage compartment in its raised position;

FIG. 13 shows a cross-sectional side view of the kit shown in FIG. 12, with one possible raising and lowering mechanism;

FIG. 14 shows another view of the kit shown in FIGS. 12 and 13, including some interior detail that is normally hidden;

FIG. 15 shows an alternative to the cabinet of FIGS. 12 to 14, as a cross-sectional view, and having a different arrangement for the raising and lowering mechanism;

FIG. 16 shows a different view of cabinet of FIG. 15;

FIG. 17 shows a cross-sectional side view of the arrangement that is shown in FIG. 12;

FIG. 18 shows a cross-sectional side view with another alternative mechanism for raising and lowering the storage compartment similar to that shown in FIG. 12;

FIG. 19 shows another arrangement utilising a cable and drum mechanism; and

FIG. 20 shows yet another arrangement utilising a cable and drum mechanism,

### BEST MODES FOR CARRYING OUT THE INVENTION

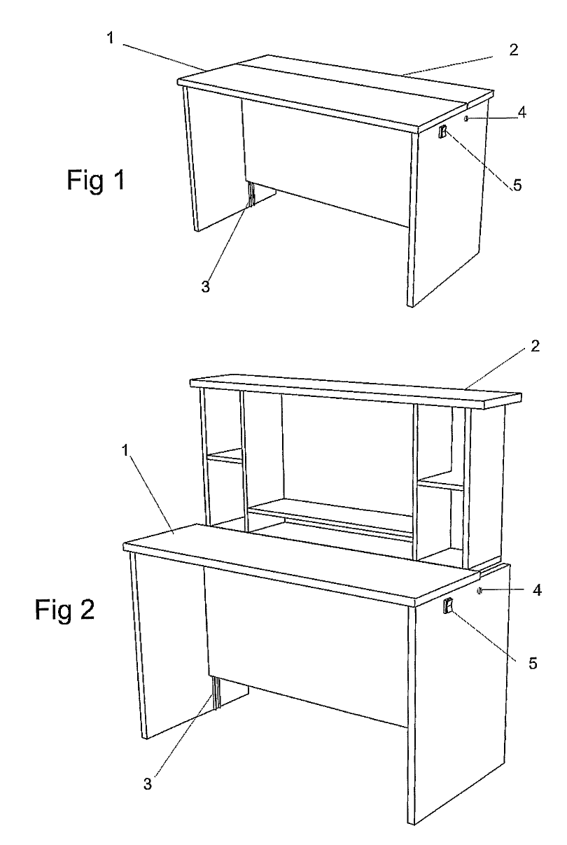

In FIGS. 1 and 2, a desk is shown, as just one possible example of an article of furniture.

The desk in FIG. 1 is shown with the storage compartment in its concealed position, while in FIG. 2 the compartment is raised to its displayed position. The invention may be applied to many different types of furniture, primarily those that utilise a horizontal working or display surface. Some examples of suitable furniture pieces include: desks, cabinets, display units, especially those for television sets and electronic equipment, shop counters, factory work benches, tables, reception desks, lecture podiums, cupboards, kitchen counters, work benches, and the like. Preferred examples of such furniture include: desks that have one or more compartments, which can be used for holding computer equipment, or in the form of bookshelves to hold books or papers; or a television cabinet for use in the lounge or bedroom of a house, which has a compartment to hold an expensive LCD or plasma type of television receiver; or a counter in a retail store for holding a computer or cash register.

The desk in FIGS. 1 and 2 has a horizontal first display surface (1) that is a section of the working area of the top of the desk, normally the front section. The desk also has a storage compartment (2) that can be raised and lowered. As shown in FIG. 2, the storage compartment has a base section, at the bottom, that is the second display surface, which in the raised position is approximately flush with the first display surface or working area (1). The compartment also is divided into smaller compartments by means of a number of shelves and vertical dividers, which can function as bookshelves or storage compartments. It has two sides and a top portion. When in its lowered storage position, as shown in FIG. 1, the top portion of the storage compartment is flush with the other section of the desk, namely the first display surface (1), so as to create a working area covering the whole surface of the desk.

In one preferred form, some guide means, such as a track (3), is positioned between the desk and the storage compartment. Such guide means may be typically be in two parts, with a first part being one or a number of channels, grooves, or runners, and with the second part being a corresponding mated tongue, ridge or protrusion that runs along the channel. One of these parts is fixed to or built into the furniture, while the other part is fixed or built in to the compartment. In the example shown in FIG. 1, at least one channel or runner is attached to or built into one of the surfaces in juxtaposition with its mated connection attached to the other surface, between the interior faces of the desk and the exterior faces of its storage compartment, respectively.

The guide means can serve a number of purposes. Most importantly they guide the compartment and limits its movements to be vertical movements. Also, they can help the storage compartment to slide more easily while being raised and lowered, particularly if the contents are unbalanced within the storage compartment. They reduce any wobble during the movements, helping prevent the contents of the storage compartment moving around. They may also reinforce the piece of furniture, making it stronger, and more able to carry the weight of the storage compartment and its contents. In one preferred form, a few simple drawer-type of runners may be attached to the desk, running vertically, each with its mating ridge or roller attached to the exterior face of the compartment.

Depending on their design, the guiding channels may also carry cables for the equipment, or the power cable for the electric motor that drives the movement. Or else, these can be handled separately.

When the storage compartment is in its lowered and concealed position, it may be locked in place, for added security if this should be desired. For instance this may be done using a keyed locking mechanism (4). The storage compartment is raised and lowered by a variety of means, including an electric motor apparatus, which may be controlled by switch (5).

The storage compartment may be any suitable shape, and have a various number of sides, keeping in mind that the furniture article itself will surround and provide an enclosure. Nevertheless, the arrangement of the walls of the compartment will depend on the need for security; if a very secure system is desired then the compartment may be enclosed on five of six of its sides, top and bottom, which provides the maximum security, and allows the objects it contains to be accessed only through its front opening or sixth side. It may even be desirable to add lockable doors or other means to protect the sixth side. If the furniture with its storage compartment is designed having aesthetics or neatness in mind, then the structure of the compartment may have fewer walls. The storage compartment may cooperate with the furniture, which may also (or instead) have security walls enclosing the compartment, when the compartment is in its lowered storage position. Furthermore, having a maximum number or side walls will also assist when lowering the compartment into storage within the article of furniture, because this will prevent objects from protruding outside the area of the compartment, and becoming jammed when it is being lowered or raised.

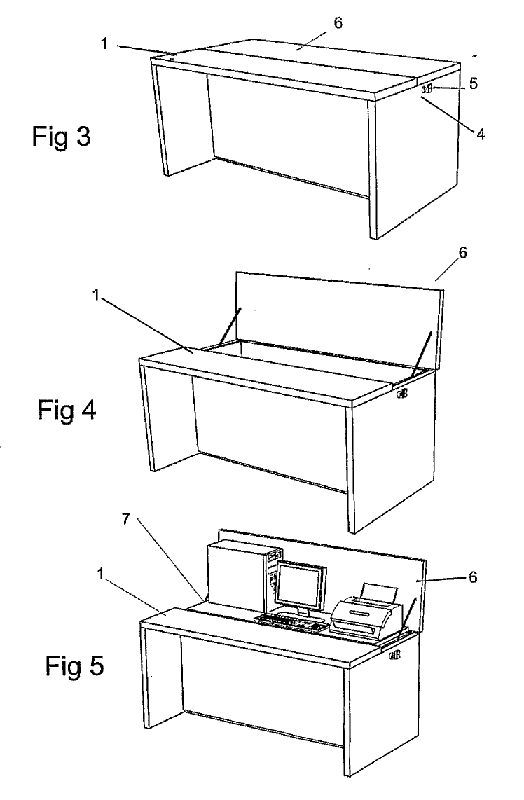

A desk with a storage compartment having two side walls, and top and bottom surfaces, and a rear wall, is shown in FIGS. 1 and 2. The desk in FIGS. 1 and 2 has a solid back, top and sides for the storage compartment, but alternatively there may only need to be a bottom surface present, as shown in FIGS. 3 to 8. The storage compartment may have only one surface, and appear as a shelf that is raised and lowered. The shelf may have a backing strip, or one or more positioning beads around its edges, to help prevent the objects from overlapping the shelf, and interfering with the lowering and raising process. When the shelf is lowered within the furniture unit, there is usually a compartment formed by the surfaces of the furniture that surround the shelf. However, the furniture may is some situations be open. The term “storage compartment” should be interpreted in its broadest sense to cover all these possibilities.

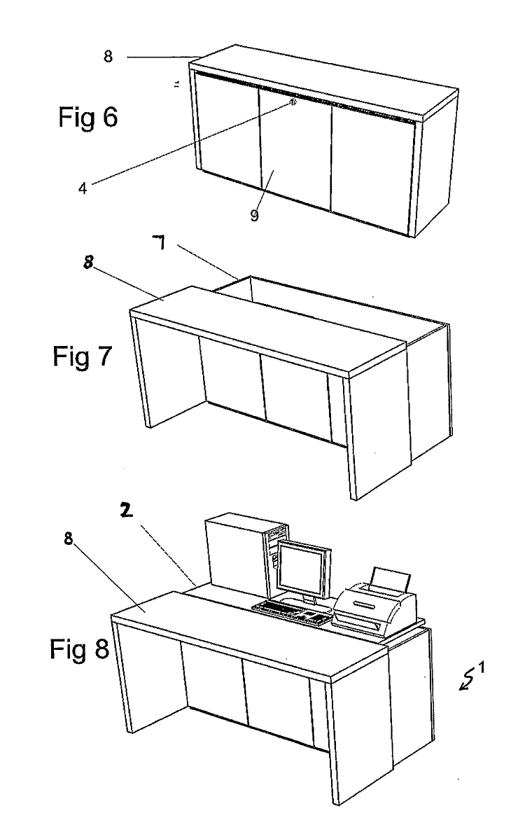

In FIGS. 3, 4 and 5, the article of furniture is also a desk (1), but having a first display surface (1) as a fixed section of its top working surface, and a storage compartment (2) which consists of a second display surface (7) being a bottom surface only, upon which computer equipment rests. There is a third display surface (6) that comprises another section of the desk top, in the form of a lid, which can be opened. This section (6) covers the storage compartment when the compartment is in its lowered and concealed position, as shown in FIG. 4. It is attached by hinges to the desk along the back edge. It is lifted to a vertical position, so as to permit the storage compartment to be raised, as shown in FIGS. 4 and 5. The section (6) is provided with retainers to prevent it opening too far, which can also hold it securely in place, if desired.

The section may be operated manually or electrically. If operated electrically, a switch, such as switch (5) may be used to operate the electric motor to open and close the section (6). Optionally, a separate keyed lock (4) may be employed to keep the compartment secure, when it is in the lowered position. Alternatively, the section (6) may be opened and closed manually, in which situation the switch (5) would not be required. Furthermore, the storage compartment (7) itself may be raised and lowered electrically or manually. It is preferably operated by electric means, in which case the switch (5) can be used to raise or lower the compartment. If both the compartment (7) and the section (6) are operated electrically, then the switch (5) can have positions to regulate all the options, or else two switches may be used.

The supporting means for the section may comprise a chain, sliding brackets, or something similar, to allow the section to be opened to the vertical position, or slightly further so as to allow gravity to hold it in place. Or, with a bracket arrangement, there may be a screw-thread and wing-nut present that can be tightened manually to hold the section (6) in place when it is open. The lid section (6) may be attached by hinges, or alternate means may be used such as a slide action, or else it may be removable, if the furniture is a shop counter that is only closed when the shop is also closed.

The furniture may be constructed of any suitable material, such as wood, metal, plastics or combinations of these. The storage compartment may be made of similar materials. If the compartment is to function as a security compartment, then its construction is preferred to be from sheet metal or similar materials, which are strong and resistant to being damaged or broken open. If aesthetic considerations are important, it may consist of attractive materials, such as wood, or coated metal sheeting, for example.

In the arrangement shown in FIGS. 3 to 5, it is generally ideal for the article of furniture to have panels or walls surrounding the storage compartment, if it is desired to keep the contents secure. However if security is not a major issue the storage compartment need not be entirely surrounded by walls, but nevertheless, for aesthetic reasons, it may be preferable to block the view of the objects within the storage compartment at least by a barrier as shown in the Figures.

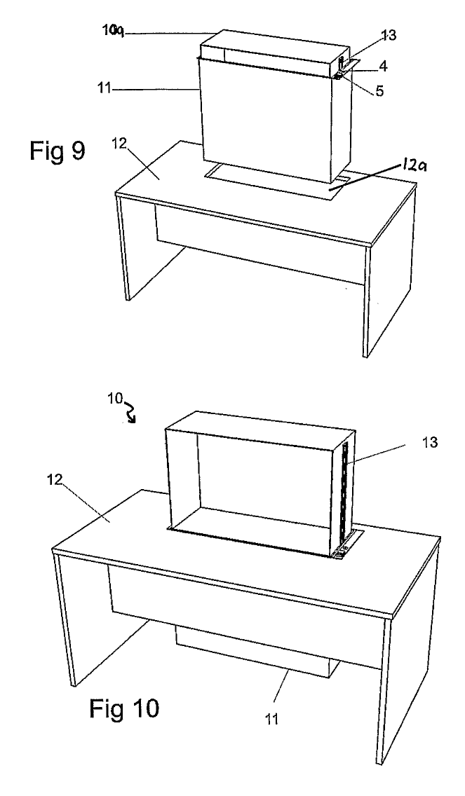

Yet another embodiment of the invention is shown in FIGS. 6, 7 and 8. This shows a buffet or cabinet (1), comprising a table structure (8) having a top and two sides, which can slide forward, to reveal the storage compartment (2) concealed within a freestanding cabinet (7). FIG. 6 shows the desk and cabinet with the storage compartment concealed, FIG. 7 shows the table section (8) expanded, and FIG. 9 shows the storage compartment (2) in its substantially raised position holding computer equipment. Generally, the raised storage compartment section of the surface (2) rises a sufficient distance so that it becomes flush with the table section (8), so that it comes to rest a little above the side walls. The table portion (8) may slide forward on wheels or castors, which are preferably hidden, optionally, with a guide (not shown). There may also be a lock mechanism (4) to prevent the cabinet being opened.

This unit also has cabinet doors (9), which may allow access to the storage compartment when it is in its stored position. Alternatively, one or all the doors may only give access to shallow cupboards, behind which the storage compartment is located, and in this situation, the table section (8) only slides forward until its rear edge is level with the edge of the storage compartment. Each of the cabinet doors (9) may have their own locks. Alternatively, the doors may be false, unable to be opened.

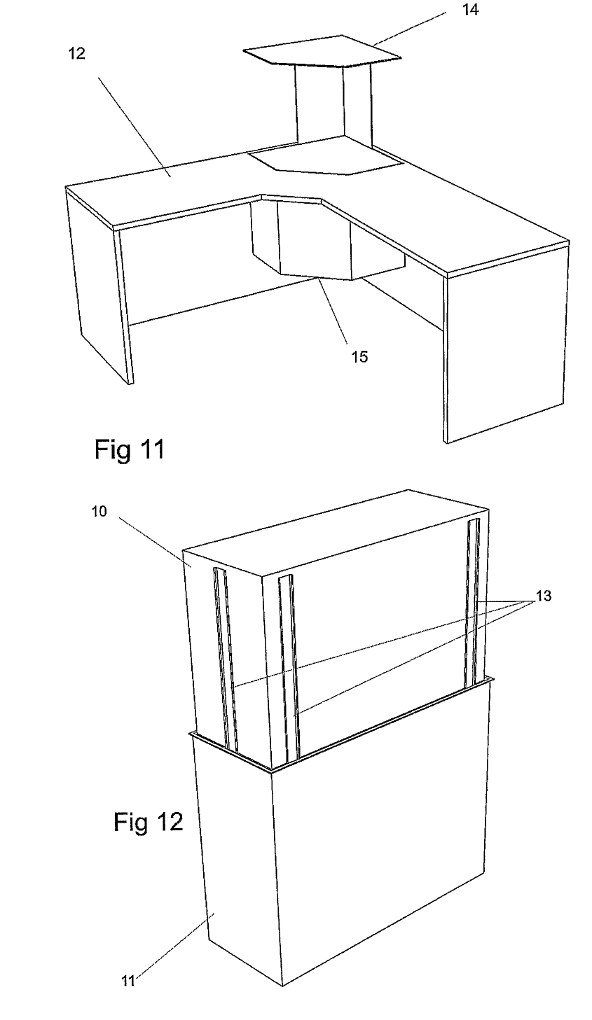

In FIG. 11, another embodiment of the invention is shown, which comprises a corner desk unit (12) having an irregularly shaped storage compartment (14). This compartment has a 5-sided bottom section, and the same shaped top section and only two side walls. The storage compartment retracts into a similarly shaped well (15), located beneath the desk. This example demonstrates that a variety of shapes may be chosen for the storage compartment according to functional and aesthetic criteria.

FIGS. 9 and 10 show a kit, or ready-to-install product (10), which can be used to install the storage compartment within an existing article of furniture (12). Firstly, a hole of suitable dimensions must be cut in the piece of furniture (12).

The kit (10) comprises the storage compartment as a separate unit, optionally together with the preferred features mentioned above. The optional features that are preferably included in the kit may include an outer container or base unit (11), in which the storage compartment unit (10a) moves, and which will hold the compartment when it is attached to the furniture and is in its concealed position. The outer container is fitted into the desk as shown in FIG. 9, into an aperture (12a) in the desk top of the right dimensions. The outer container may have a flange on one or more sides, to help with its fitting and to hold the lock (4) and motor control switch (5), if these are included with the kit. In this situation, the kit would also include the driving motor unit that can raise and lower the compartment, as well as means to attach the motor cables to the furniture, and to control and power it.

The storage compartment may include guidance means, such as a track (13), to assist with the movement, which may be drawer runners or guides which are mounted inside the outer container (or on the furniture surfaces if there is no outer container), to mate with grooves or channels on the outer surface of the compartment walls. The compartment runs along these guides when moving, operating more smoothly. Any type of guidance means may be employed. These may include a track, within which the compartment, or a protrusion on the compartment runs. Ball bearings, rollers, a carriage or the like may also be involved to minimise friction.

FIG. 12 shows more detail for the kit, and shows the rear view of the outer container (11) and its storage compartment (10). Due to the relatively large size of the compartment, in this situation it is often advisable to include some guidance means, which in this example comprise a number of drawer runners (13) mounted vertically on the compartment that mate with their complimentary grooves that are formed on the inside surfaces of the walls of the base unit (11). Such guides are particularly advantageous to help prevent the storage cabinet from tilting or jamming when it is travelling, especially in the situation where it is being driven by a single cable.

A variety of mechanisms for raising and lowering the compartment are possible, including: a cable and drum mechanism, a rack and pinion mechanism, a chain and sprocket mechanism, and a linear actuator mechanism. Of these, the cable and drum mechanism is preferred, due to its reasonable cost, relative simplicity, and capacity of raising relatively heavy weights. These mechanisms may be operated manually, but are preferably electrically powered. FIGS. 13 to 20 show a variety of methods for raising and lowering the storage compartment, comprising different arrangements for the preferred approach, of a drum and cable mechanism.

In FIG. 13, there is a side cross-sectional view of the kit comprising the outer container (11) with the storage compartment (10) that can be raised or lowered by means of an electrically powered motor and a drum (14) that winds a cable (16) that also passes over a pulley or roller-guide wheel (15). The motor may be controlled by a rocker-type power switch, which has a central “off” position, and selectable positions at either end for driving the drum in each direction to either raise or lower the storage compartment.

It is preferred that some type of limiting means is used to prevent the compartment moving beyond its end points. This may be a physical barrier to prevent the compartment from moving beyond its end points, or some electronic or electrical means, that are common in this field, which stops the motor from running once the compartment has reached its limits. A combination of both these methods is especially preferred. Some types of cable and drum-type electric motors have built in and adjustable cut-offs (or limit switches) that will operate when the cable that is being round around the drum is tensioned, which can operate automatically when the container meets a stop, and ceases to move. Such motors, especially tubular motors that are used to power blinds or the like, are preferred for use in the present invention.

It is also preferred that the article of furniture (or the kit form for installing a storage compartment) may include a means for adjusting the alignment of the first and second surfaces. A variety of approaches can be adopted for this purpose. It may take the form of one or more threaded screws or the like, which can be extended or retracted a short distance, and against which the storage compartment is stopped at the end of its travels. Alternatively, the screw or similar mechanism may alter the vertical height of one or more of the pulleys, in a drum/cable driving mechanism, that govern the extent of movement of the storage compartment. Additionally, this adjustment means may be used to align the ends of the storage compartment, so that they also are level and horizontal, as well as being aligned flush with the first surface, should this require adjusting. By adjusting these screws, the surfaces can be perfectly aligned. Over time they may require occasional re-adjustment. Other means for aligning the coplanar or flush surfaces may also be employed.

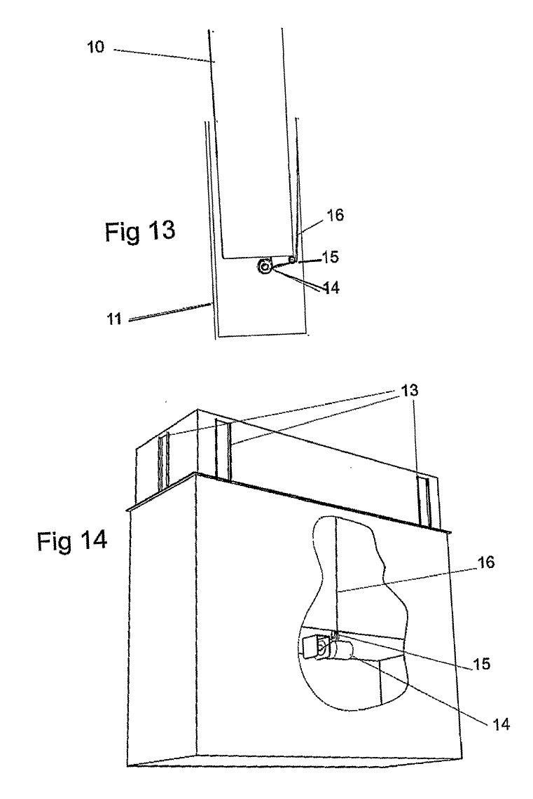

FIG. 14 shows an exploded perspective view of the drum and cable arrangement that is shown in FIGS. 12 and 13. There is an electric motor that powers a drum (14), which is connected to the cable (16), and the cable (16) runs over a pulley (15).

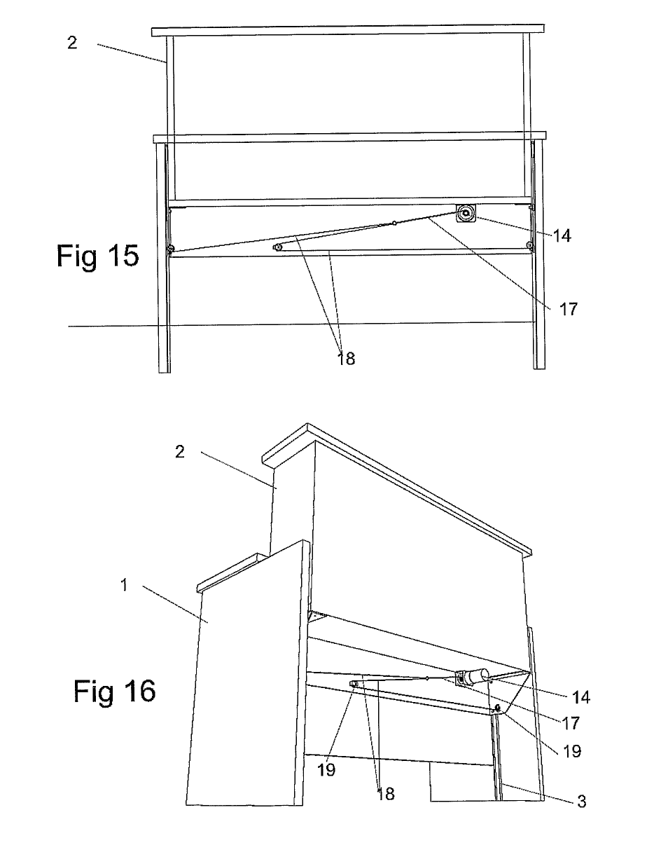

In FIGS. 15 and 16, a different arrangement for the cable attachment is shown, which is particularly suited for wide storage compartments that have a tendency to become unbalanced. In this example, the motor and drum (14) winds a cable (17) that splits into two parts (18), with each of the two end cables running over one or two pulleys (19) and then attaching to each side of the storage compartment. The cables may run near to the guidance tracks (13), before being attached to each of the sides of the cabinet.

Another approach to aligning the surfaces can be employed, by connecting the ends of the cables to an alignment means, which comprises a screw-threaded and adjustable tensioning means on the end of each cable. By winding the tensioning means one way or the other the length of the cables can be altered, to allow the top of the storage compartment to be level. Over time, as the cable stretches, the tensioning means may need further adjustments.

Especially when the storage compartment is wide, there is the possibility that a heavy object may be placed inside it at one edge, which may unbalance the unit. This situation may be handled by including guides (as shown in FIG. 12 for example), but also by using the arrangement for the driving cables as shown in FIGS. 15 and 16. The storage compartment, even when containing an unbalanced weight, will travel more easily when two cables that support it and drive its travels are attached on opposite sides of the unit. Vertical movements are synchronised and the compartment is less sensitive if its contents should be unbalanced by being located at one end of the compartment.

As a further aid in keeping the storage compartment balanced, it is preferred to attach the cables to each end of the compartment, at or near its centre balance point, particularly if a cable is used for attachment to each end of the compartment. Other approaches may be used, such as using two or more cables at each end, or splitting a single cable to have two (or more) attachment points. But multiple attachment points can be harder to align properly than with a single one that is attached to the compartment at each end and especially centred. This approach can also be combined with one or more guides for the compartment.

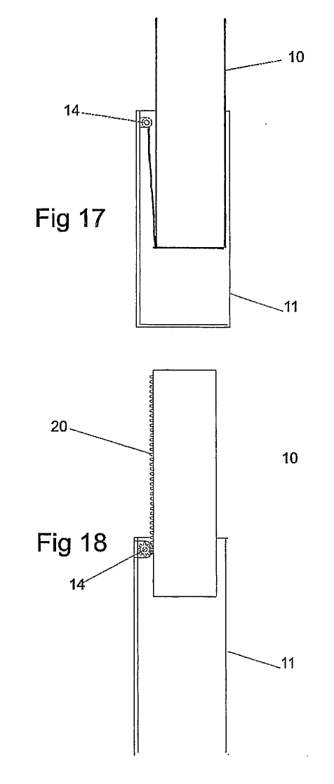

FIGS. 17 and 18 are cross-sectional side views of two alternate arrangements featuring a container (11) that contains a storage compartment (10); FIG. 17 shows a simple arrangement for the cable and drum (14), where the motor is not mounted on the storage compartment, but on the furniture body. FIG. 18 shows similar situation, but with a rack and pinion mechanism comprising a toothed rack (20) that engages with a gear wheel or rack (14). Again for particularly wide units, one rack and pinion mechanism may not be sufficient to allow for smooth movement, but in this situation two or more units can be used, connecting each such pinion with a shaft.

In addition to having a powered electric motor driving the movement of the storage compartment, it may be moved by hand without any motor. In this situation, the cabinet may be counter-balanced, to make the movement easier, or the movement may be driven by winding a crank by hand, which may also include some gearing to make the job easier. Optionally, springs may be employed with manually operated units to assist with the movement.

It is also possible to utilise a brake of other means, to hold or lock the compartment in its raised position. A manually operated brake mechanism, such as a ratchet and pawl (or clank) that can be engaged and manually released may be used to lock the compartment in its raised position, if necessary. However, if a cable and drum power unit is utilised, this can normally by itself hold the compartment at any appropriate height without further assistance.

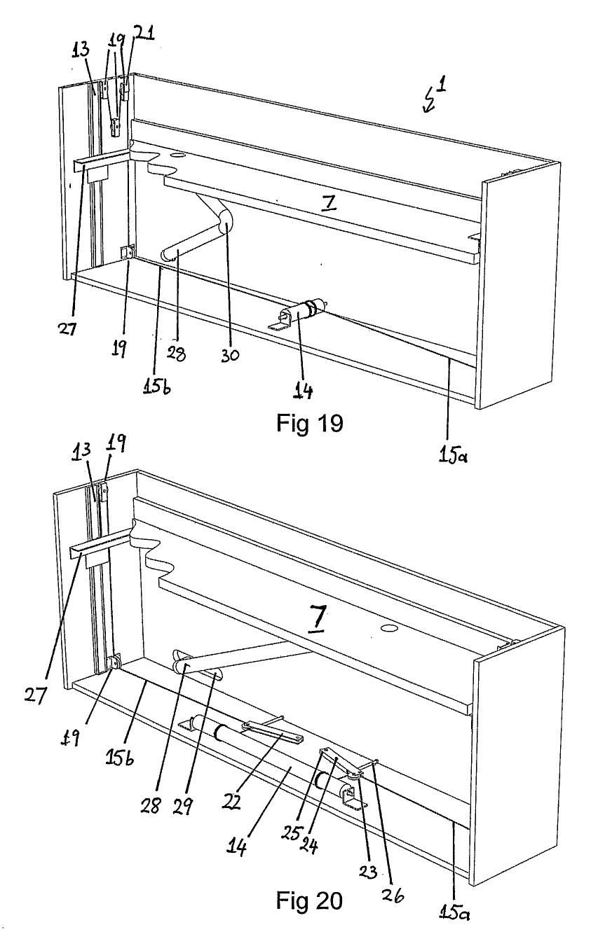

FIGS. 19 and 20 show two additional variations for the raising and lowering mechanism. These show a portion of an article of furniture like that shown in FIG. 3 or 6.

In FIG. 19, a cable and drum (14) “tubular” motor, of a type that can be used to raise and lower blinds or garage doors, is fixed to the base of the furniture unit (1). Two cables (15a, 15b) are wound around the drum (14) portion of the motor. When the drum (14) rotates on its axis in one or other direction the cables are either wound in or else released. The two cables (15a, 15b) are passed over a number of pulleys (19) and then attach at or near the centre of the storage compartment shelf (7) (which can have side walls and a top), at each end. A guide (13) is also positioned at each end of the cabinet fixed to its sides. There is also shown a simple alignment system (21), that ensure it aligns precisely flush with the desk top and is horizontal, when in its raised position. The shelf can sit on a rest (27).

There can be three of pulleys (19) on each side wall of the unit. The cable is looped through these pulleys following an “S”-shaped path, before being fixed to the shelf or compartment. One of the upper pulleys (21) can be adjustable in a vertical direction, which allows the play of the cable to be extended or retracted. The adjustment may be by means of a screw thread that allows the pulley to be moved up and down a certain distance, and held there. This allows the horizontal alignment of each end of the shelf to be adjusted by altering one or other of these pulleys, or allows the flush alignment of the entire shelf to be altered by adjusting both pulleys together. The screw and thread (or other) type of mechanism for moving the top pulley up and down, is positioned at the top of each side of the furniture, which gives a user easy access to the adjustment mechanism. As a further alternative, there can be a nut that supports the shelf, attached to a thread, which can be raised or lowered to level the shelf unit. Also normally the length of the cable should be initially selected to align the shelf correctly, but this mechanism can fine-tune the level, as well as allow for later adjustments due to any stretching of the cable over time.

Another approach is shown in FIG. 20, which shows a similar portion of the furniture article (1) as in FIG. 19. The tubular motor (14) is fixed to the base of the unit in a different orientation to that in FIG. 19. This arrangement is more convenient for shallow furniture articles. Two cables (15a, 15b) are wound around the drum (14). They pass through two fine adjustment mechanisms (22). These allow the reach of each cable to be extended or reduced, in order to allow for fine adjustment of the shelf (7), to which the cables are attached. The fine adjustment operates by having an adjustment pulley (23) that is attached to an arm (24) one end (25) of which is fixed to the furniture article, allowing partial rotation about the axis of fixture (25). A further adjustable arm (26) that can comprise an adjustable and threaded screw attaches the other end of the arm (24) to the unit, and permits precise rotation of the pulley (23), which extends or reduces the play of the cable that runs over the pulley. This mechanism also redirects the cable running from the drum to the pulleys (19) on the side wall of the article, changing the cable's direction by about 90°. The screw that controls the amount of retraction for the arm (26) is located outside and at the rear of the unit. A user can therefore operate the screw to retract or release the adjustment mechanism (22) from behind the furniture article without disassembling the unit.

The cables also attach to a shelf rest (27) at around its centre or balance point, and a guide channel (13) also helps control the movement of the shelf (7) as it moves up and down. The two cables (15a, 15b) are passed over a number of pulleys (19) and then attach to the centre of the shelf (7)

If the furniture unit is intended for electronic equipment, such as computer equipment or a television set, then it may be advisable to provide a conduit, for power or other cables, leading from the shelf to the rear (or side) the unit at or near its base. However, a connection by the most direct path can potentially cause problems when the storage compartment is raised and lowered. The cables will also be required to move with the unit, and may not be able to stretch the distance, if they were initially connected up when the unit is in its lowered position, for instance. Therefore it is another preferred feature of the invention to provide a cable guide, linking the storage unit to near to the base of the furniture article. The guide is so arranged to minimise the change in the length of the path though the cable guide as the storage compartment moves up and down. One approach is for the guide to be approximately movable or rotatable in an arc about the lower connection, between the compartments lowered and raised positions, preferably with little if any stretching. Such a guide (28) is shown in FIGS. 19 and 20.

Preferably the cable guide (28) is in the form of a tube of a sufficient diameter to hold power cords, computer cables, television cables and the like, and to also allow their ends to pass through. A plastic tube with a diameter of about 40 to 60 mm is ideal. The conduit may be of any suitable material, including plastic, and may preferably be smooth to allow an easy insertion of cable through it.

One orientation of the guide that will limit any stretching as the compartment moves up and down, is to have the guide travelling from the base at one side, over to the shelf or compartment at the opposite side of the unit, as shown in FIG. 20. As the compartment is raised or lowered, the guide will mostly rotate in an arc around the lower attachment point. A small amount of give will be required, with a straight conduit, and the lower attachment point can be designed to allow for this give or movement. A suitable such means of attachment may be a short slot (29) within which the lower attachment point may move.

Alternatively, the conduit may contain a flexible elbow (30) as shown in FIG. 19, allowing a further pivot of the upper and lower sections of the guide around the elbow joint, as the compartment travels up and down.

The same approach as shown in FIGS. 19 and 20 may also be applied to the kit form of the invention.

It will be apparent that obvious variations or modifications may be made in accordance with the spirit of the invention that are intended to be part of the invention, and therefore fall within the scope of the invention.

1. An article of furniture having, a substantially horizontal first display surface, a concealable storage compartment having at least one substantially horizontal second display surface for storing objects, wherein said storage compartment may be repetitively raised substantially vertically from a fixed and concealed position to a fixed and displayed position, and lowered back again, and when in said fixed and displayed position, said first and second display surfaces are substantially flush, and when in said fixed and concealed position said storage compartment is substantially concealed from view within said article of furniture.

2. The article of furniture according to claim 1, wherein said concealable storage compartment has a bottom surface comprising said second display surface, at least one side surface, and a top surface, and when said storage compartment is in said fixed and concealed position said top surface is substantially flush with said first display surface.

3. The article of furniture according to claim 1, wherein said concealable storage compartment has a bottom surface comprising said second display surface, and when in said fixed and concealed position said storage compartment is substantially concealed within said article of furniture by being covered by a substantially horizontal third display surface that then may be displaced to permit said storage compartment to be raised, and when in said fixed and displayed position, said third display surface is substantially flush with said first display surface.

4. The article of furniture according to claim 3, wherein said third display surface is pivoted along an axis that is one edge of said third surface.

5. The article of furniture according to claim 1, wherein said concealable storage compartment has a bottom surface comprising said second display surface, and when in said fixed and concealed position said storage compartment is substantially concealed within said article of furniture by being covered by said first display surface that then may be displaced substantially horizontally to allow said storage compartment to be raised, and when in said fixed and displayed position, said second display surface is substantially flush with said first display surface.

6. (canceled)

7. The article of furniture according to claim 1, which includes first locking means to secure said storage compartment when in its concealed position.

8. The article of furniture according to claim 7, where said first locking means is itself concealed.

9. The article of furniture according to claim 7, wherein said first locking means is a keyed lock.

10. The article of furniture according to claim 1, where said storage compartment is substantially entirely enclosed when in its concealed position so as to secure the objects in said storage compartment.

11. The article of furniture according to claim 10, wherein said storage compartment has an outer container into which it is lowered, and substantially entirely encloses it when in its concealed position, so as to secure the objects in said storage compartment.

12. The article of furniture according to claim 1, wherein said storage compartment is held in its fixed and displayed position by second locking means.

13. The article of furniture according to claim 1, which also includes guidance means to assist with guiding the up and down movement of said storage compartment.

14. The article of furniture according to claim 1, which also includes adjustment means to allow said first and second display surface to be aligned more precisely flush with each other.

15. The article of furniture according to claim 1, which may be raised or lowered by substantially electrically operated means.

16. The article of furniture according to claim 13, wherein said electrically operated means includes control means in the form of a switch.

17. The article of furniture according to claim 1, wherein the means for said raising and lowering is selected from among: a cable and drum mechanism, a rack and pinion mechanism, a chain and sprocket mechanism, or a linear actuator mechanism.

18. The article of furniture according to any one of claims 17, wherein the means for said raising and lowering is a cable and dram mechanism.

19. The article of furniture according to claim 18, wherein said cable and drum mechanism includes two or more cables connecting said storage compartment to said drum mechanism around which said cables are wound, and wherein a cable is fixed to each end of the storage compartment, and at or near the centre balance point of said compartment.

20. The article of furniture according to claim 18, wherein the cable passes over two or more pulleys, at least one of which can be repositioned to extend or reduce the total path of each cable's travel, and thereby allowing adjustment of the alignment of the storage compartment relative to said first display surface.

21. The article of furniture according to claim 1, which also includes a cable guide for containing cables, that extends between said storage compartment and near to the base of the article of furniture, said cable guide so arranged to minimise the change in the length of the path though said cable guide as said storage compartment moves up and down.

22. A kit for adapting an article of furniture to include a storage compartment, said article of furniture having a substantially horizontal first display surface, and within said surface having an aperture of dimensions to permit said storage container to pass through, said kit comprising, a concealable storage compartment having at least one substantially horizontal second display surface for storing objects, and said kit has means for permitting said storage compartment to be repetitively raised substantially vertically from a fixed and concealed position within said article of furniture to a fixed and displayed position, and lowered back again, and when in said fixed and displayed position, said first and second display surfaces are substantially flush, and when in said fixed and concealed position said storage compartment is substantially concealed from view within said article of furniture.

23. The kit according to claim 22, wherein said concealable storage compartment has a bottom surface comprising said second display surface, at least one side surface, and a top surface, and when said storage compartment is in said fixed and concealed position said top surface is substantially flush with said first display surface.

24. The kit according to claim 22, wherein said concealable storage compartment has a bottom surface comprising said second display surface, and when in said fixed and concealed position said storage compartment is substantially concealed within said article of furniture by being covered by a substantially horizontal third display surface that then may be displaced to permit said storage compartment to be raised, and when in said fixed and displayed position, said third display surface is substantially flush with said first display surface.

25. The kit according to claim 22, said storage compartment has an outer container into which it is lowered, and substantially entirely encloses it when in its concealed position, so as to secure the objects in said storage compartment.

26. The kit according to claim 22, which also includes first locking means to secure said storage compartment when in its concealed position.

27. (canceled)

28. (canceled)

29. (canceled)

30. (canceled)

31. (canceled)

32. (canceled)

33. (canceled)
